(19) United States
(12) Patent Application Publication
(10) Pub. No.: US 2025/0056780 A1
(43) Pub. Date: Feb. 13, 2025

(54) DETERMINING AN ASSEMBLING RISK FOR AN ELECTRONIC COMPONENT TO BE MOUNTED TO A PRINTED CIRCUIT BOARD

(71) Applicant: Siemens Industry Software Inc., Plano, TX (US)

(72) Inventor: Guy Shoshany, Ganei Tikva (IL)

(21) Appl. No.: 18/723,665

(22) PCT Filed: Jan. 6, 2022
(86) PCT No.: PCT/IB2022/050080

§ 371 Date: Jun. 24, 2024

(51) Int. Cl. H05K 13/08; G06F 30/398; G06F 111/20; G06F 115/12

(52) U.S. Cl. CPC H05K 13/085; G06F 30/398; G06F 2111/20; G06F 2115/12

(57) ABSTRACT

A method and a system for determining an assembling risk for an electronic component to be mounted to a printed circuit board. The method includes the following steps: providing a component library with a number of electronic components and its specific component identifier; wherein the component identifier includes an identifier string of letters and numbers providing information on a number of physical attributes of the electronic component; providing an evaluation scheme for each of the number of physical attributes; selecting an electronic component from the component library and evaluating each of the physical attributes; determining for each of the physical attributes the intermediate risk value and calculating from the intermediate risk values a final risk score; and determining the assembling risk associated with the final risk score by comparing the final risk score with a pre-defined risk scale.

### TECHNICAL FIELD

The present disclosure is directed, in general, to computer-aided systems for Printed Circuit Board (“PCB”) and Surface-Mount Technology (“SMT”) manufacturing and board quality inspection and analysis. More in particular, the disclosure is directed to software systems and applications related to the determination of an assembling risk for an electronic component that is intended to be mounted to a printed circuit board.

### BACKGROUND OF THE DISCLOSURE

In electronics manufacturing, the testing operations of manufactured PCB/SMT boards are sensitive and critical processes.

In manufacturing facilities of SMT and PCB assembly lines, Automated Optical Inspection (“AOI”) machines are usually employed in order to test the quality of the manufactured boards.

Typically, the various different AOI machines of the diverse vendors automatically scan the boards and provide outcome inspection reports with a “PASS” or “FAIL” quality status score for the inspected boards. Particularly, these machines focus on the quality of the soldering of the electronic components to the PCB.

Further analysis is currently made to the component spacing in order to safeguard a sufficient space between the electronic components and between the lines of the PCB, specifically to avoid the electronic components won't be mounted on top of each other.

Furthermore, a soldering analysis is performed in order to make sure that the leads of the electronic components are placed correctly on the soldering pads of the PCB enabling thereby the correct soldering of the electronic component on the board.

Even after this analysis, the operator may find electronic components that have not been soldered properly to the PCB.

Therefore, techniques for improving the detection of possible misalignment of the electronic components with the respective PCB are desirable already during the engineering phase of the design of the PCB and its electronic circuitry.

### SUMMARY OF THE DISCLOSURE

Various disclosed embodiments include methods, systems, and computer readable mediums for determining an assembling risk for an electronic component that is intended to be mounted to a printed circuit board (PCB), the method comprising the step of providing a component library comprising a number of electronic components and its specific component identifier wherein said component identifier comprises an identifier string of letters and numbers thereby providing an information for a number of physical attributes of the electronic component. Further, an evaluation scheme is provided for each of the number of physical attributes thereby enabling an assignment of an intermediate risk value to each of the number of physical attributes. Now, a number of electronic components is selected from the component library and each of the number of physical attributes in terms of the respective information given in the identifier string against the respective evaluation scheme is evaluated. For each of the number of physical attributes the intermediate risk value is determined and a final risk score is calculated from these intermediate risk values. The method further comprises the step of determining the assembling risk associated with the final risk score by comparing this final risk score against a pre-defined risk scale.

Thus, the physical attributes of the electronic components are considered during the engineering phase of the PCB as an influential factor in the determination of the soldering risk when the electronic components will be soldered to the PCB during the assembly of the PCB.

Various disclosed embodiments include methods, systems, and computer readable mediums in a manner that the assembling risk provides an information on a probability of a misalignment of soldering of the electric leads of the electronic component to the printed circuit board.

Various disclosed embodiments include methods, systems, and computer readable mediums, wherein the number of physical attributes comprise one of the more of the following component attribute:
a) form of the leads and their alignment with the printed circuit board prior to the soldering;
b) position of the leads of the electronic component;
c) body size of the electronic component; and
d) number of leads.

Various disclosed embodiments include methods, systems, and computer readable mediums wherein the pre-defined risk table comprises a number of risk classes.

The method of any of the preceding claims, wherein the final risk core is the result of the sum of all the intermediate risk values.

Various disclosed embodiments include methods, systems, and computer readable mediums wherein the step of determining the assembling risk further comprising to set a threshold value for the assembling risk and wherein a warning is generated if the final risk score violates the threshold value for a pre-defined number of electronic components that are engineered to be assembled to the printed circuit board.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented.

FIG. 2 schematically illustrates a user interface that provides a final risk score for an electronic component having a VPKG code as specific component identifier.

FIG. 3 schematically illustrates an evaluation scheme for the physical attribute of the lead form of an electronic component listed in a component library.

FIG. 4 schematically illustrates an evaluation scheme for the physical attribute of the position of the leads of the electronic component introduced in FIG. 3.

FIG. 5 schematically illustrates an evaluation scheme for the physical attribute of the number of the leads of the electronic component introduced in FIG. 3.

FIG. 6 schematically illustrates an evaluation scheme for the physical attribute of the body size of the electronic component introduced in FIG. 3.

FIG. 7 illustrates a flowchart of a method for for determining an assembling risk for an electronic component that is intended to be mounted to a printed circuit board.

### DETAILED DESCRIPTION

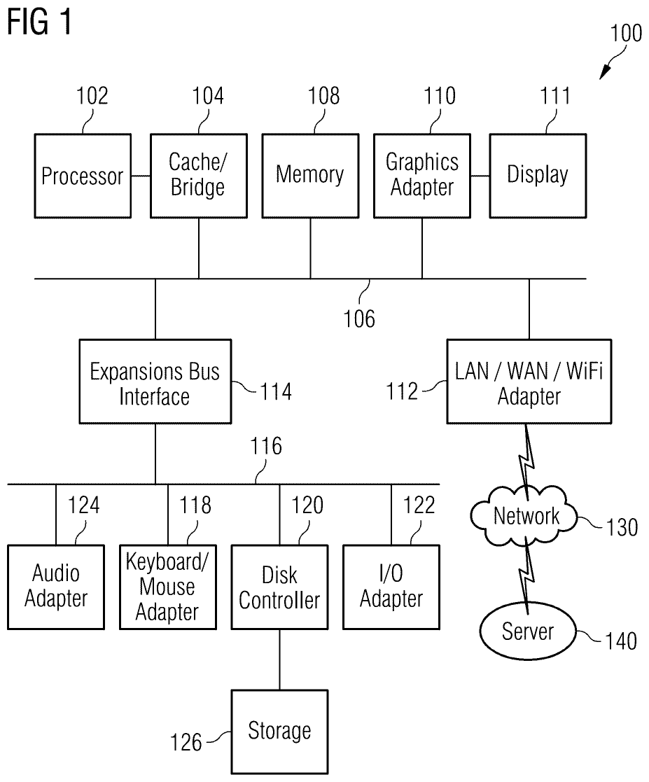

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Furthermore, in the following the solution according to the embodiments is described with respect to methods and systems for determining an assembling risk for an electronic component that is intended to be mounted to a printed circuit board.

Features, advantages, or alternative embodiments herein can be assigned to the other claimed objects and vice versa.

In other words, claims for methods and systems for determining an assembling risk for an electronic component that is intended to be mounted to a printed circuit board can be improved with features described or claimed in context of the methods and systems for determining an assembling risk for an electronic component that is intended to be mounted to a printed circuit board.

As used herein, the terms “PCB boards”, “SMT boards” and simply “boards” denote electronic circuits composed of a plurality of electronic components being connected via their respective leads to the board by conductive wires or traces.

Typical examples of electronic components include, but are not limited by, resistors, transistors, capacitors, inductors, and diodes.

As used herein, the term “component” is meant in a broader sense to denote any element or feature of the board, including for example the traces, which can be subject to the method for determining the assembling risk for an electronic component that is intended to be mounted to a printed circuit board.

As used herein, the term “assembling risk” broadly denotes “any error or any defect on components and on solder joints and on any other features of the board” including, for example, defects on one or more of the following board features: area defects, billboarding, component offset, component polarity, component presence or absence, component skew, marking, excessive solder joints, flipped component, height defects, insufficient paste around leads, insufficient solder joints, lifted leads, no population tests, paste registration, severely damaged components, tombstoning, volume defects, wrong part, solder bridging, presence of foreign material on the board, line width violations, spacing violation, excess copper, missing pad-a feature that should be on the board is missing, short circuits, gold finger damage, cuts, hole breakage-a drilled hole (via) is outside of its landing pad, wrong mounting components identified, through-hole pins, lifted lead, golden finger scratch/blur (where part of the above examples are taken from the Wikipedia page on AOI machine).

Previous techniques did not enable an efficient method for determining an assembling risk for an electronic component that is intended to be mounted to a printed circuit board PCB prior to the manufacturing of the boards in an electronics shop floor. The embodiments disclosed herein provide numerous technical benefits, including but not limited to the following examples.

Embodiments reduce the assembling risk for an electronic component that is intended to be mounted to a printed circuit board already during the engineering phase of the PCB.

Embodiments reduce the probability that during the manufacturing/assembling phase of the PCB, the risk for a misalignment of the electronic component is made as low as possible prior to the shop floor phase.

FIG. 1 illustrates a block diagram of a data processing system 100 in which an embodiment can be implemented, for example as a PDM system particularly configured by software or otherwise to perform the processes as described herein, and in particular as each one of a plurality of interconnected and communicating systems as described herein. The data processing system 100 illustrated can include a processor 102 connected to a level two cache/bridge 104, which is connected in turn to a local system bus 106. Local system bus 106 may be, for example, a peripheral component interconnect (PCI) architecture bus. Also connected to local system bus in the illustrated example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but are not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware illustrated in FIG. 1 may vary for particular implementations. For example, other peripheral devices, such as an optical disk drive and the like, also may be used in addition or in place of the hardware illustrated. The illustrated example is provided for the purpose of explanation only and is not meant to imply architectural limitations with respect to the present disclosure.

A data processing system in accordance with an embodiment of the present disclosure can include an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

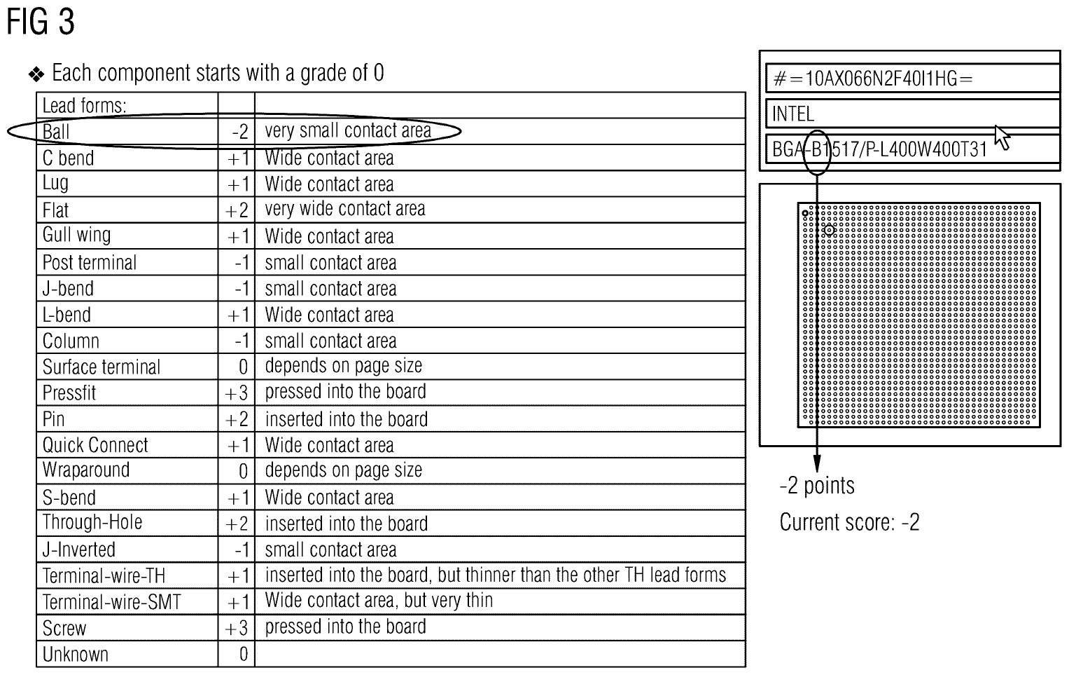

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. FIG. 3 schematically illustrates a block diagram for training a function with a ML algorithm for modeling a false error detector in accordance with disclosed embodiments.

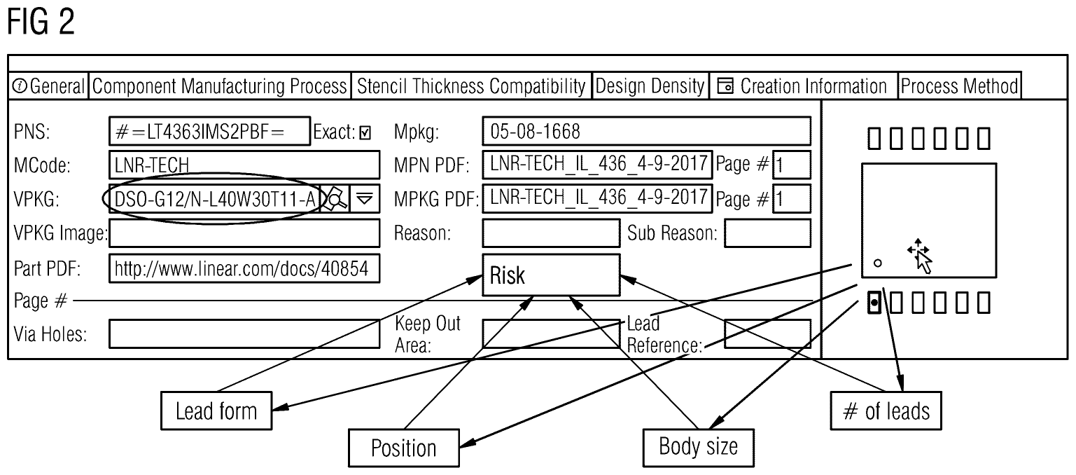

FIG. 2 schematically illustrates a user interface 200 that provides a final risk score for an electronic component having a VPKG code as specific component identifier.

This user interface 200 provides an overview of the data being required to identify the respective electronic component. With respect to the present risk assessment of the assembling risk, the relevant data is provided by the specific component identifier 202 in the field “VPKG”. This component identifier 202 comprises an information of the four physical attributes relevant to the present method of determining the assembly risk. The four physical attributes are the lead form, the position of the lead, the number of the leads and the size of the body of the electronic component. The final risk score for the respective electronic component which is derived from the evaluation of these four attributes is displayed in a separate field 204 giving the personnel already during the engineering phase a hint or suggestion where probably mounting risks may occur during the assembly of the PCB at shop floor. Depending on the completeness of the component library, the user may find directly the final risk score for a frequently used electronic component.

FIG. 3 now schematically illustrates an evaluation scheme for the physical attribute of the lead form of an electronic component listed in a component library. The VKPG for the electronical components sounds as follows: BGA-B1517/P-L400W400431. The B as shown in FIG. 3, right part, indicates that the leads have a ball form and therefore provide only a very small contact area for the soldering process. To this specific property, the evaluation scheme assigns a value “−2” for this physical attribute. FIG. 3, left part, shows the possible form of the leads considered for the evaluation and the intermediate risk value assigned to the respective lead form. Each electronical component starts at a value of ZERO. Thus, after the evaluation of the first physical attribute of the lead form the intermediate score is at a value of “−2”.

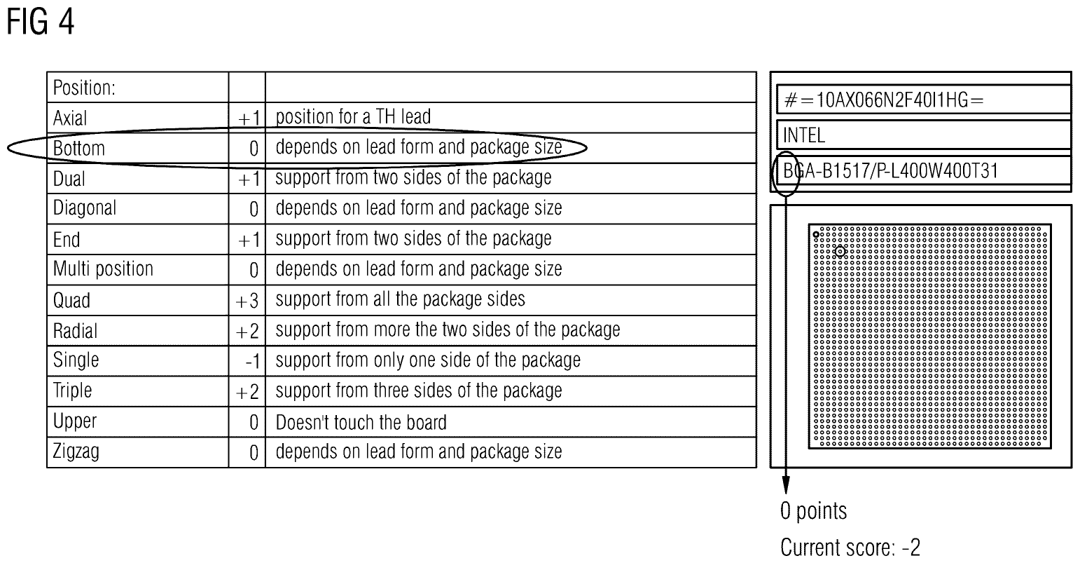

FIG. 4 schematically illustrates an evaluation scheme for the physical attribute of the position of the leads of the electronic component introduced in FIG. 3. Here, the first letter “B” in the VKPG indicates that the lead are positioned at the bottom of the electronical component. Thus, an intermediate risk value of “0” is assigned to this property leading to a current total score of “−2”. The table in FIG. 4, left part, here provides a list of possible positions of the leads and the intermediate risk values assigned to the respective lead position.

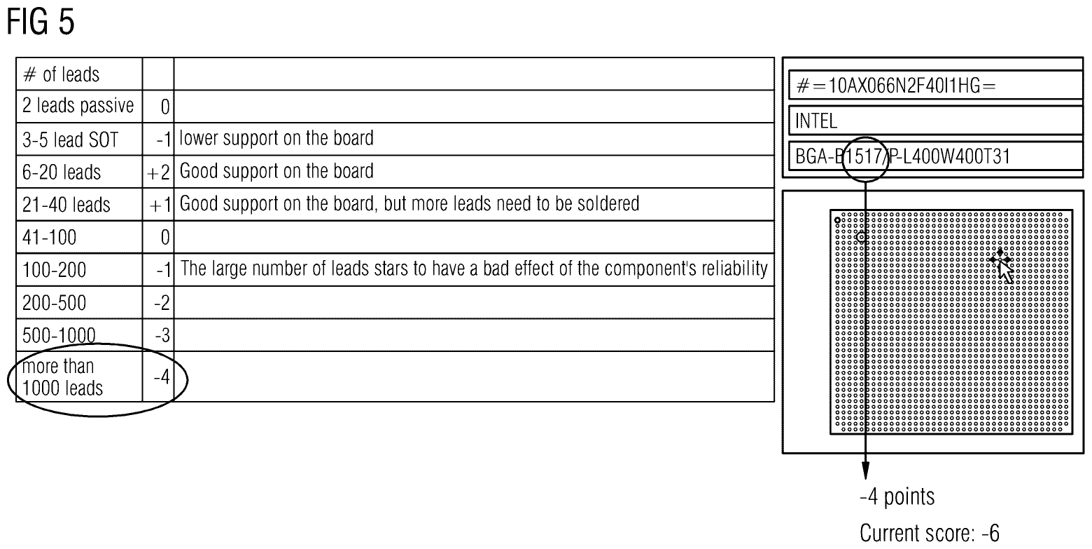

FIG. 5 schematically illustrates an evaluation scheme for the physical attribute of the number of the leads of the electronic component introduced in FIG. 3. Here, the number “1517” in the VKPG indicates that the electronical component has 1517 leads. Thus, an intermediate risk value of “−4” is assigned to this property leading to a current total score of “−6”. The table in FIG. 5, left part, here provides a list of different ranges of the number of leads and the intermediate risk values assigned to the respective effective number of leads.

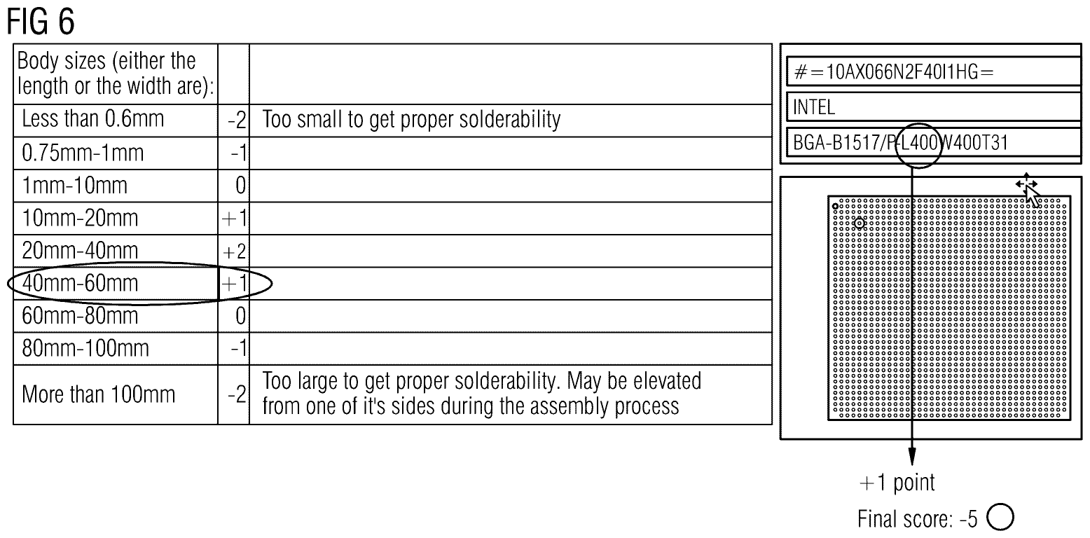

FIG. 6 schematically illustrates an evaluation scheme for the physical attribute of the body size of the electronic component introduced in FIG. 3. Here, the string “L400 W” in the VKPG indicates that the electronical component has a size of 40 mm×40 mm. Thus, an intermediate risk value of “1” is assigned to this property leading to a final risk score of “−5”. The table in FIG. 6, left part, here provides a list of different ranges of the size of the body of the electronic component and the intermediate risk values assigned to the respective body size.

All the evaluation schemes shown above reflect the user experience with respect to the effective quality of the soldering achieved for a large variety of electronic components. Thus, the intermediate values properly reflect the risk of all the physical attributes for the overall quality of the soldering at shop floor. Thus, the final risk score is compared against a pre-defined risk scale determining the assembling risk associated with the final risk score. As an example, three risk scales (risk classes) can be defined. The high risk class is assigned to a final risk score of equal or lower than −4. A medium risk value is assigned to a final risk score between −3 and 0. And a low risk class is assigned to a final risk score higher than 0. Thus, the electronic component discussed above having a final risk score of “−5” is considered a high risk component.

Further, this evaluation can be done for all electronic components that are intended to be mounted/assembled to a distinct PCB. Consequently, an arithmetic mean can be calculated for the PCB as a whole and the risk assignment can be made according to the above-mentioned risk classes. Of course, the electronic components may have also additional weighting factors according to their assembly complexity, for example due to the size and the number of leads of the electronic component.

Thus, the present invention leverages the data that can be stored in the component library to perform this analysis already at engineering level. The component library can form a unique tool that provides accurate physical models of the electronic components and connectors used in PCB manufacturing, test and assembly, and can be delivered in a consistent, EDA-friendly interface. This library may contain billions of manufacturers' part numbers.

Each electronic component has a graphic package, which is represented by a string of letters & numbers, based on JEDEC standards, which is called VPKG as already mentioned above. From the VPKG the present invention looks at four physical attributes that have an effect on the way that the component will be soldered to the printed circuit board:

Lead form-leads with a larger surface area (such as Gull-Wing or C-Bend) have better chances to be soldered properly to the board than leads with a smaller surface area (such as Ball, which touches the board only in one point). Leads that are inserted into the board (such as Press-Fit leads) will have a better hold of the PCB than SMT leads that only touch the surface of the PCB. These exemplary considerations form the basis for the evaluation scheme that is presented in FIG. 3.

Lead position—the form in which the leads are organized around the component's body. Components that have leads surrounding the body from four sides (position Quad) should have a better hold of the PCB than components that have leads coming from only one side of the component (position Single). These exemplary considerations form the basis for the evaluation scheme that is presented in FIG. 4.

Body size-very large components (body more than 8 cm) have the risk that one side of the component will be soldered properly but the other side will not, which will cause this component's side to be lifted from the board and have insufficient soldering. Very small chip components (less than 0.6 mm) carry the same risk because they may be too small to be soldered properly. These exemplary considerations form the basis for the evaluation scheme that is presented in FIG. 5.

Number of leads-components with a large number of leads carry the risk that not all the leads will be soldered properly. This exemplary consideration forms the basis for the evaluation scheme that is presented in FIG. 6.

A combination of all of these factors creates the final risk score for each of the billions of components that may be present in the component library. In the example above, the final risk score has been calculated as the sum of the intermediate risk value for all the four physical attributes. Of course, a weighting factor may be introduced to this evaluation since for example the number of leads may have a higher risk for the proper mounting of the component to the PCB than the other physical attributes.

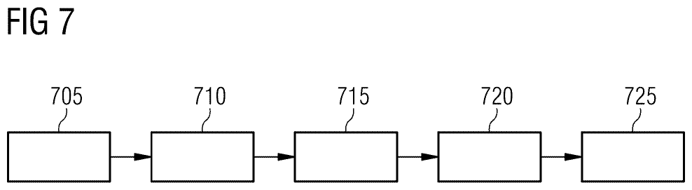

FIG. 7 illustrates a flowchart of a method for determining an assembling risk for an electronic component that is intended to be mounted to a printed circuit board in accordance with disclosed embodiments. Such method can be performed, for example, by system 100 of FIG. 1 described above, but the “system” in the process below can be any apparatus configured to perform a process as described.

At act 705, a component library is provided that comprises a number of electronic components and its specific component identifier wherein said component identifier comprises an identifier string of letters and numbers thereby providing an information for a number of physical attributes of the electronic component.

At act 710, an evaluation scheme for each of the number of physical attributes is provided thereby enabling an assignment of an intermediate risk value to each of the number of physical attributes.

At act 715, an electronic component is selected from the component library and each of the number of physical attributes is evaluated in terms of the respective information given in the identifier string against the respective evaluation scheme present for this physical attribute.

At act 720, for each of the number of physical attributes the intermediate risk value is determined and a final risk score is calculated from the intermediate risk values.

At act 725, the assembling risk associated with the final risk score is determined by comparing the final risk score against a pre-defined risk scale.

In some embodiments, the method also calculates the average quality score of all the electronic components on the design for the planned PCB. As an example, the sum of all the final risk scores (quality scores) of all the electronic components on the board is divided by the number of components on the board. Thus, this embodiment is able to yield an average quality score of the board which can be coded in colour and displayed in the user interface 200 giving a status color:
High risk board-average final risk score is equal or lower than −4
Medium risk board-average risk score is between −3 to 0
Low risk board-risk score is higher than 0

Based on this data, the user can replace risky components in the design and reduce the risk for the assembling of the entire board before it is being sent to production.

Prior art didn't take under consideration the physical attributes of the electronical components as an influential factor on the way that they will be soldered to the printed circuit board. This present invention exemplarily discloses an embodiment that takes four different physical attributes of a component and combines then into one model that can assess the component risk level and the entire board risk level.

Thus, the key of the customer value is the ability of the user to consider the replacement of some electronical components on the board early in the design phase, before purchasing the components. Further, the risk of soldering a risky part onto his board is reduced thereby also reducing costs and re-engineering or re-manufacturing that may happen by using too risky components.

Those skilled in the art will recognize that, for simplicity and clarity, the full structure and operation of all data processing systems suitable for use with the present disclosure is not being illustrated or described herein. Instead, only so much of a data processing system as is unique to the present disclosure or necessary for an understanding of the present disclosure is illustrated and described. The remainder of the construction and operation of data processing system 100 may conform to any of the various current implementations and practices known in the art.

It is important to note that while the disclosure includes a description in the context of a fully functional system, those skilled in the art will appreciate that at least portions of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims.

1-18. (canceled)

19. A method for determining an assembling risk for an electronic component to be mounted to a printed circuit board, the method comprising:
providing a component library with a number of electronic components and specific component identifiers, each component identifier including an identifier string of letters and numbers providing information on a number of physical attributes of the electronic component;
providing an evaluation scheme for each of the number of physical attributes, thereby enabling an assignment of an intermediate risk value to each of the number of physical attributes;
selecting an electronic component from the component library and evaluating each of the number of physical attributes in terms of the respective information given in the identifier string against a respective evaluation scheme;
determining for each of the number of physical attributes an intermediate risk value and calculating from the intermediate risk values a final risk score; and
determining the assembling risk associated with the final risk score by comparing the final risk score against a pre-defined risk table.

20. The method according to claim 19, wherein the assembling risk provides information on a probability of a misalignment of soldering of electric leads of the electronic component to the printed circuit board.

21. The method according to claim 20, wherein the number of physical attributes comprise one or more component attributes selected from the group consisting of:
a) a form of the leads and an alignment thereof with the printed circuit board prior to the soldering;
b) a position of the leads of the electronic component;
c) a body size of the electronic component; and
d) a number of leads.

22. The method according to claim 19, wherein the pre-defined risk table comprises a number of risk classes.

23. The method according to claim 19, wherein the final risk score is a sum of all the intermediate risk values.

24. The method according to claim 19, wherein the step of determining the assembling risk further comprises setting a threshold value for the assembling risk, and wherein a warning is generated when the final risk score overshoots the threshold value for a pre-defined number of electronic components that are engineered for mounting on the printed circuit board.

25. A data processing system, comprising:
a processor; and
an accessible memory, the data processing system being configured to:
provide a component library with a number of electronic components and a specific component identifier thereof, wherein the component identifier comprises an identifier string of letters and numbers thereby providing an information for a number of physical attributes of the electronic component;
provide an evaluation scheme for each of the number of physical attributes thereby enabling an assignment of an intermediate risk value to each of the number of physical attributes;
select an electronic component from the component library and evaluate each of the number of physical attributes in terms of the respective information given in the identifier string against a respective evaluation scheme;
determine for each of the number of physical attributes the intermediate risk value and calculate from the intermediate risk values a final risk score; and
determine the assembling risk associated with the final risk score by comparing the final risk score against a pre-defined risk table.

26. The data processing system of claim 25, wherein the assembling risk provides information on a probability of a misalignment of soldering of the electric leads of the electronic component to the printed circuit board.

27. The data processing system according to claim 26, wherein the number of physical attributes comprise one or more component attributes selected from the group consisting of:
a) a form of the leads and an alignment thereof with the printed circuit board prior to the soldering;
b) a position of the leads of the electronic component;
c) a body size of the electronic component; and
d) a number of leads.

28. The data processing system according to claim 25, wherein the pre-defined risk table comprises a number of risk classes.

29. The data processing system according to claim 25, wherein the final risk score is a sum of all the intermediate risk values.

30. The data processing system according to claim 25, wherein determining the assembling risk includes to set a threshold value for the assembling risk and wherein a warning is generated when the final risk score overshoots the threshold value for a pre-defined number of electronic components that are engineered for mounting to the printed circuit board.

31. A non-transitory computer-readable medium encoded with executable instructions that, when executed, cause one or more data processing systems to:
provide a component library with a number of electronic components and specific component identifiers thereof, wherein the component identifier has an identifier string of letters and numbers thereby providing information for a number of physical attributes of the electronic component;
provide an evaluation scheme for each of the number of physical attributes thereby enabling an assignment of an intermediate risk value to each of the number of physical attributes;
select an electronic component from the component library and evaluate each of the number of physical attributes in terms of a respective information given in the identifier string against a respective evaluation scheme;
determine for each of the number of physical attributes an intermediate risk value and calculate from the intermediate risk values a final risk score; and
determine the assembling risk associated with the final risk score by comparing the final risk score against a pre-defined risk table.

32. The non-transitory computer-readable medium of claim 31, wherein the assembling risk provides information on a probability of a misalignment of soldering of electric leads of the electronic component to the printed circuit board.

33. The non-transitory computer-readable medium according to claim 32, wherein the number of physical attributes comprise one or more component attributes selected from the group consisting of:
a) a form of the leads and an alignment thereof with the printed circuit board prior to the soldering;
b) a position of the leads of the electronic component;
c) a body size of the electronic component; and
d) a number of leads.

34. The non-transitory computer-readable medium according to claim 31, wherein the pre-defined risk table comprises a number of risk classes.

35. The non-transitory computer-readable medium according to claim 31, wherein the final risk score is a sum of all the intermediate risk values.

36. The non-transitory computer-readable medium according to claim 31, wherein the data processing system is further configured to set a threshold value for the assembling risk and to cause a warning to be generated if the final risk score violates the threshold value for a pre-defined number of electronic components that are engineered for mounting on the printed circuit board.
